(19) United States
(12) Patent Application Publication
(10) Pub. No.: US 2006/0171003 A1
(43) Pub. Date: Aug. 3, 2006

(54) Image formation system and image formation device

(76) Inventor: Hideharu Yoneoka, Ibaraki-ken (JP)

Correspondence Address: Matthew K Ryan;Frommer Lawrence & Haug, 745 Fifth Avenue, New York, NY, 10151, US

(21) Appl. No.: 10/564,248

(22) PCT Filed: Jul. 13, 2004
(86) PCT No.: PCT/JP04/10281

§ 371 Date: Jan. 11, 2006

(30) Foreign Application Priority Data
Jul. 14, 2003 (JP) 2003-196362
Jul. 12, 2004 (JP) 2004-204080

(51) Int. Cl. H04N 1/46

(52) U.S. Cl. 358/540

(57) ABSTRACT

To improve the printing efficiency in an image forming system for forming a fixed image on one sides of a plurality of recording media and variable images different from each other on the other sides of the recording media.

Fixed image data output from a controller (21) is stored in a storage portion (25) of a printer (22) and the fixed image data stored in the storage portion (25) is read out by an image formation control means (27) to form a fixed image on one side of a plurality of recording media and at the same time, a plurality of pieces of the variable image data output from the controller (21) are received to form variable images on the other sides of a plurality of the recording media, whereby the number of times which the fixed image data is transferred from the controller (21) to the printer (22) can be reduced, and the fixed image transfer time is shortened.

### FIELD OF THE INVENTION

This invention relates to an image forming system for forming a fixed image on one sides of a plurality of recording media and variable images different from each other on the other sides of the recording media and an image forming apparatus for the image forming system.

### BACKGROUND OF THE INVENTION

Recently, with wide use of an ink jet printer and/or a laser printer, there has been developed a printer system where the printers are connected to a computer by way of various interfaces to print image data output from the computer. Further, as disclosed in Japanese Unexamined Patent Publication No. 2001-130668, a printer system which is able to make a double-side printing.

In a printer system which is able to make a double-side printing as described above, sometimes, images of the same pattern are printed on the back side and images different from each other by addresses are printed on the front side as in printing of New Year's cards. Conventionally, in such a case, for instance, the controller which controls, for instance, output of the image data to the computer or the printer generates image data so that the image data to the front side and the image data to the back side are alternately output, and output the image data to the printer in sequence as shown in FIG. 6.

However, if the image data to the front side and the image data to the back side are alternately output, the image data to the back side must be output a plurality of times, which wastes the transfer time of image data.

In view of the foregoing observations and description, the primary object of the present invention is to provide an image forming system and an image forming apparatus for forming fixed images on one sides of a plurality of recording media and variable images different from each other on the other sides of the recording media which system and apparatus can shorten the image data transfer time and can improve the printing efficiency and an image forming apparatus for the image forming system.

### SUMMARY OF THE INVENTION

In accordance with the present invention, there is provided a first image forming system which is for forming a fixed image on one sides of a plurality of recording media and variable images different from each other on the other sides of the recording media and comprises a printing information output unit which outputs fixed image data representing the fixed image and a plurality of pieces of variable image data each representing a variable image, and an image forming apparatus which forms images on opposite sides of the recording media on the basis of the fixed image data and the variable image data output from the printing information output unit, wherein the improvement comprises a storage portion which is provided in the image forming apparatus to store the fixed image data output from the printing information output unit, a printing information output control means which causes the storage portion to store the fixed image data output from the printing information output unit and to hold the stored fixed image data until it is used for image formation of the fixed image on a plurality of recording media, and an image formation control means which controls the image forming apparatus to read out the fixed image data held in the storage portion to form fixed images on one sides of a plurality of recording media and to receive a plurality of pieces of the variable image data output from the printing information output unit to form variable images on the other sides of a plurality of the recording media.

In the first image forming system described above, the printing information output unit may display in a list a plurality of pieces of information representing a plurality of pieces of fixed image data which are stored in advance, and at the same time, may have a fixed image selecting means through which image data representing a fixed image to be formed on said one sides of the recording media can be selected out of the plurality of fixed image data.

In accordance with the present invention, there is further provided an image forming apparatus which is for a first image forming system described above and comprises a storage portion which stores the fixed image data output from the printing information output unit, and an image formation control means which controls the image forming apparatus to read out the fixed image data held in the storage portion to form fixed images on one sides of a plurality of recording media and to receive a plurality of pieces of the variable image data output from the printing information output unit to form variable images on the other sides of a plurality of the recording media.

The “printing information output unit” as used here may be any so long as it can output the fixed image data and the variable image data. For example, the printing information output unit may be a computer which can edit image data and can output the image data in a printer language or a scanner which reads out an original and outputs the image data read out. Further, the printing information output unit may be of a combination of the computer and the scanner. Further, the printing information output unit may include a controller which carries out predetermined processing on the image data output from the computer or the scanner and/or controls output of the image data to the image forming apparatus.

The “image forming apparatus” may be any so long as it can form images on opposite sides of a plurality of recording media and, for instance, may be an ink jet printer or a laser printer.

Further the “storage portion” may be any so long as it stores the fixed image data and, for instance, may use a semiconductor memory. The “storage portion” need not be limited to those which store only the fixed image data but may be used as a buffer memory which temporarily stores variable image data output from the printing information output unit as well stores the fixed image data.

The expression “to receive a plurality of pieces of the variable image data output from the printing information output unit” includes not only to directly receive the variable image data output from the printing information output unit but also to receive the variable image data output from the printing information output unit by way of, for instance, a buffer memory.

Further, as “the information representing the fixed image data” may comprise a filename of the fixed image data.

The expression “to display in a list” may either be to display “the information representing the fixed image data” in a table or to display “the information representing the fixed image data” by switching in sequence. Further, all the plurality of pieces of information representing a plurality of pieces of fixed image data which are stored in advance need not be displayed but only a part thereof may be displayed. A plurality of pieces of fixed image data may be grouped and information representing the group may be displayed. The pieces of fixed image data in a group may be displayed when information representing the group is selected.

In accordance with the present invention, there is further provided a second image forming system which is for forming a fixed image on one sides of a plurality of recording media and variable images different from each other on the other sides of the recording media and comprises a computer which outputs variable image data representing the variable image of a plurality of pages, a controller which is provided with a variable image data receipt portion which receives the variable image data output from the computer and an image storage portion which stores a plurality of pieces of fixed image data each representing a fixed image, and outputs the variable image data received by the variable image data receipt portion and a fixed image data stored in the image storage portion and a printer which forms images on opposite sides of the recording media on the basis of the fixed image data and the variable image data output from the controller, wherein the improvement comprises that the computer outputs to the controller fixed image designation information for designating one of the plurality of pieces of fixed image data, the controller selects one of the plurality of pieces of fixed image data from the image storage portion on the basis of the fixed image designation information output from the computer and outputs the selected fixed image data to the printer and thereafter outputs the variable image data of the plurality of pages to the printer, and the printer is provided with a storage portion which stores the fixed image data output from the controller, a printing information output control means which causes the storage portion to store the fixed image data and to hold the stored fixed image data until it is used for image formation of the fixed image on a plurality of recording media, and an image formation control means which controls the image forming apparatus to read out the fixed image data held in the storage portion to form fixed images on one sides of a plurality of recording media and to receive a plurality of pieces of the variable image data output from the controller to form variable images on the other sides of a plurality of the recording media.

In the second image forming system, the controller and the printer may be formed integrally with each other.

In accordance with the first image forming system and the first image forming apparatus, since the fixed image data output from the printing information output unit is stored in the storage portion provided on an image forming apparatus, the stored image data is held in the storage portion until it is used for image formation of the fixed image on a plurality of recording media, the fixed image data held in the storage portion is read out to form fixed images on one sides of a plurality of recording media and a plurality of pieces of the variable image data output from the printing information output unit is received to form variable images on the other sides of a plurality of the recording media, the number of times which the fixed image data is transferred from the printing information output unit to the image forming apparatus can be reduced and the fixed image transfer time is shortened, whereby the printing efficiency can be improved.

Further, when the fixed image selecting means of the printing information output unit displays in a list information representing a plurality of pieces of fixed image data which are stored in advance and the information representing fixed image data of a fixed image to be formed on one side can be selected from information representing the plurality of pieces of fixed image data, the user can easily set or change the fixed image.

In accordance with the second image forming system, since a computer is caused to output to a controller fixed image designation information for designating one of the plurality of pieces of fixed image data, the controller selects one of the plurality of pieces of fixed image data from the image storage portion on the basis of the fixed image designation information output from the computer and outputs the selected fixed image data to the printer and thereafter outputs the variable image data of the plurality of pages to the printer, and the printer stores in a storage portion the fixed image data output from the controller, holds the stored fixed image data until it is used for image formation of the fixed image on a plurality of recording media, reads out the fixed image data held in the storage portion to form fixed images on one sides of a plurality of recording media and receives a plurality of pieces of the variable image data output from the controller to form variable images on the other sides of a plurality of the recording media, a desired fixed image can be easily selected from a plurality of fixed images without unnecessarily increasing the traffic between the computer and the controller, whereby the number of times which the fixed image data is transferred from the controller to the printer can be reduced, the fixed image transfer time is shortened, and the printing efficiency can be improved.

### BRIEF DESCRIPTION OF THE DRAWINGS

FIG. 1 is a block diagram showing a printer system employing an image forming system in accordance with an embodiment of the present invention,

FIG. 2 is a view showing in brief the structure of the printer system shown in FIG. 1,

FIG. 3 is a view showing an example of the setting window displayed in the printing information output means of the printer system shown in FIG. 1,

FIG. 4 is a view showing another example of the setting window displayed in the printing information output means of the printer system shown in FIG. 1,

FIG. 5 is a block diagram showing the operation of the printer system shown in FIG. 1, and

FIG. 6 is a view for illustrating the conventional printer system.

### PREFERRED EMBODIMENTS OF THE INVENTION

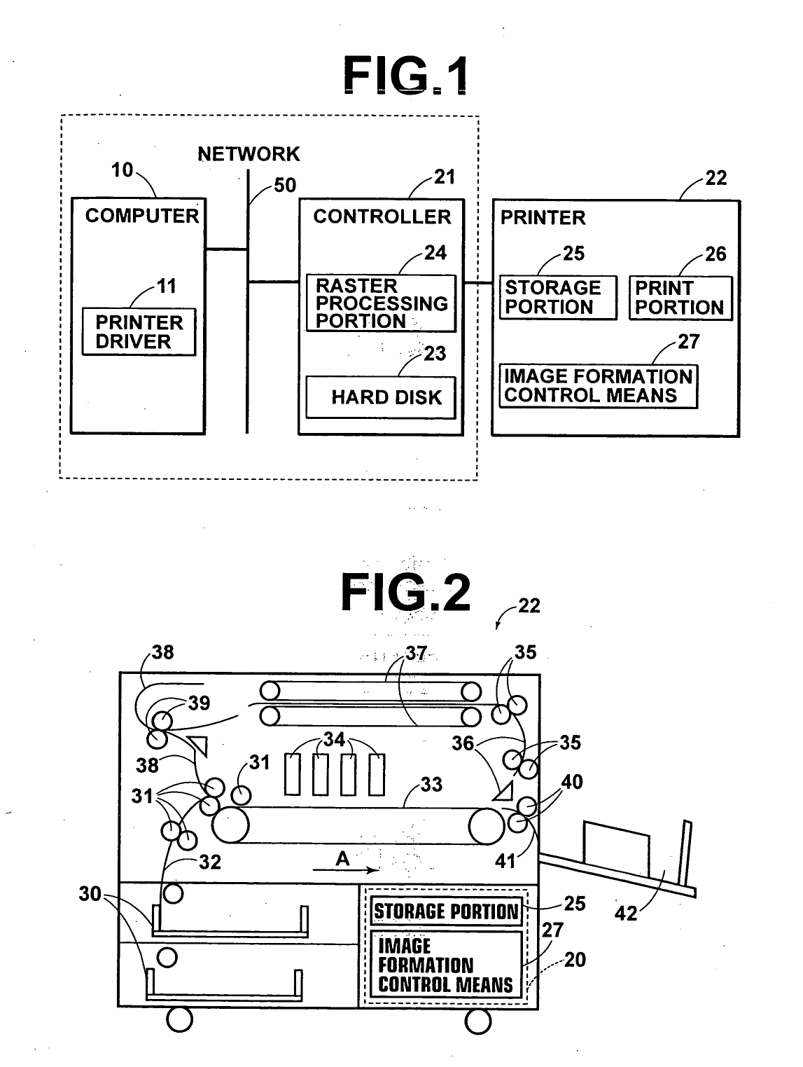

A printer system employing an image forming system in accordance with an embodiment of the present invention will be described in detail with reference to the drawings, hereinbelow. The printer system is for forming a fixed image on one sides of a plurality of recording media and variable images different from each other on the other sides of the recording media. FIG. 1 is a view showing in brief the printer system.

As shown in FIG. 1, the printer system comprises a computer 10 having a printer driver 11 which outputs fixed image data representing the fixed image, variable image data representing the variable image and double-side printing information which instructs that the fixed image and the variable image are to be printed on each side of the recording media, a controller 21 which carries out predetermined image processing on image data output from the computer 10 and controls output of the processed image data to a printer 22 (to be described later), and the printer 22 which carries out the double-side printing on the basis of the fixed image data and the variable image data. In this embodiment, the computer 10 and the controller 21 form the printing information output unit of this invention and the printer 22 forms the image forming apparatus of this invention.

The computer 10 can edit the fixed image data and the variable image data with application installed therein. The computer 10 transforms the image data edited by the application into those in a printer language with the printer driver 11 and outputs to the controller 21 by way of a network 50 the transformed image data together with the double-side printing information.

The controller 21 comprises a hard disk 23 which stores the image data in the printer language output from the computer 10 and input thereinto through the network 50 and a raster processing portion 24 which carries out raster processing on the image data which is stored in the hard disk 23, for instance, on the basis of the double-side printing information. Then the controller 21 outputs to the printer 22 double-side printing information and the image data which has undergone the raster processing. Further, the controller 21 is provided with three kinds of output queues, a direct queue, a hold queue and a form queue. The direct queue carries out the raster processing by the raster processing portion 24 on image data as soon as the image data in the printer language is input into the controller 21. The hold queue is an output queue which stores in the hard disk 23 the image data input into the controller 21 in the printer language as it is. The form queue is an output queue which stores in the hard disk 23 the image data input into the controller 21 in the printer language as it is as the hold queue. However, in the case of the image data stored in the hard disk 23 by the form queue, the filename thereof is displayed by the computer 10 when the printing information is set in the computer 10.

The printer 22 comprises a storage portion 25 which stores the raster-processed image data output from the controller 21, a print portion 26 which carries out the double-side printing on the basis of the input image data, and an image formation control means 27 which controls the print portion 26 so that the print portion 26 reads out the fixed image data stored in the storage portion 25 to print out the fixed image on one side of a recording medium and receives the variable image data output from the printing information output unit to print the variable image on the other side of the recording medium. In this particular embodiment, the storage portion 25 of the printer 22 comprises a semiconductor memory and holds the fixed image data representing the fixed image printed on one side of a plurality of recording media, until the printing of the fixed image data is ended, while temporarily storing the variable image data to be printed on the other side of the plurality of recording media. Accordingly, the storage portion 25 has at least a capacity corresponding to image data of two pages of a maximum paper size. Further, the image formation control means 27 in this particular embodiment has also a function of the printing information output control means as said in this invention. Though, in this embodiment, the arrangement is as described above, the arrangement need not be limited to as described above, and, for example, the function of the printing information output control means as said in this invention may be carried by the controller.

The network 50 shown in FIG. 1 may be either of a general wire line or of a communication line such as LAN. Further, the network may include wireless LAN.

FIG. 2 shows in brief the printer 22. As shown in FIG. 2, the printer 22 in this embodiment is provided with a double-side reversing unit of switchback system and carries out continuously a front-side printing and a back-side printing for one recording medium.

Specifically, the printer 22 comprises a recording medium loading portion 30 in which recording media which have not been printed are loaded, transfer rollers 31 and a transfer passage 32 for transferring the recording media taken out from the recording medium loading portion 30 to a transfer belt 33, the transfer belt 33 which transfers the recording media transferred by the transfer rollers 31 and the transfer passage 32 to an ink jet head 34, the ink jet head 34 which makes print by injecting ink onto the recording medium from head portions respectively provided therein by four components, the Y (yellow) component, M (magenta) component, C (cyan) component and K (black) component, transfer rollers 35 and a transfer passage 36 for transferring the recording media which have been printed on one side thereof by the ink jet head 34 to a reverse transfer belt 37, the reverse transfer belt 37 which transfers the one-side printed recording media transferred by the transfer rollers 35 and the transfer passage 36 to a reverse transfer passage 38, reverse transfer rollers 39 and the reverse transfer passage 38 which reverses and transfer again to the transfer belt 33 the one-side printed recording media transferred by the reverse transfer belt 37, paper discharge rollers 40 and a paper discharge passage 41 which discharge the double-side printed recording media which have been printed also on the other side thereof by the ink jet head 34 on the transfer belt 33 and a paper discharge tray 42 which receives the double-side printed recording media which are discharged by the paper discharge rollers 40 and the paper discharge passage 41.

Further, the printer 22 is provided with a control board 20 on which the storage portion 25 comprising a semiconductor memory and the image formation means 27 are mounted.

Though a printer of switchback system is employed in this embodiment as described above, any printer may be employed so long as it can carries out the double-side printing. For example, the printer may be of an intermediate tray system wherein one-side printed recording media are once stored in, for instance, an intermediate tray and then printed on the other side thereof.

Operation of this printer system will be described next.

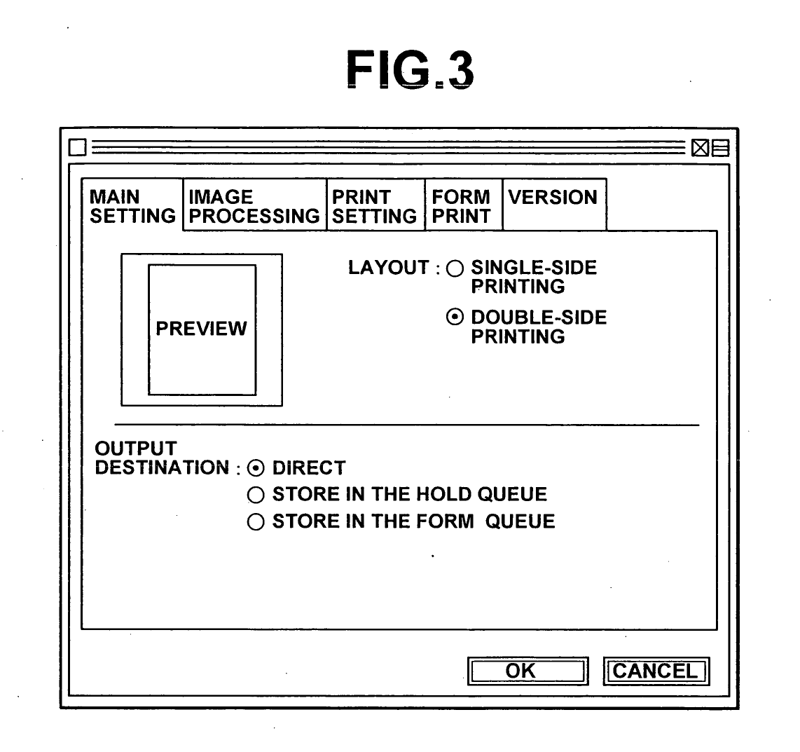

When printing is instructed in an application such as for editing an image installed in the computer 10, a setting window shown in FIG. 3 is displayed on a monitor (not shown) by the printer driver 11. In the main setting screen of this setting window, the double-side printing is selected as the “layout” and the direct queue is selected as the “output destination”.

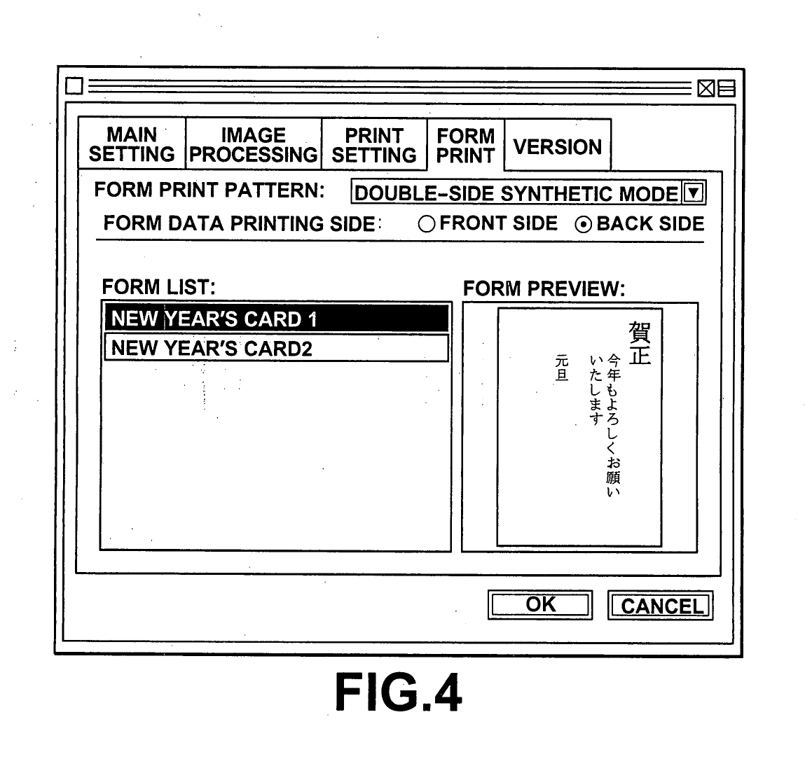

When the setting tub of the form printing is selected in the setting window described above, the form printing screen such as shown in FIG. 4 is displayed. In this form printing screen, the double-side synthetic mode is selected as the “form printing pattern” and the side of the recording media on which the fixed image data is to be printed is selected in the “printing side of the form data”. The front side and the back side of the recording media is determined on the basis of the manner in which the recording media are loaded in the recording medium loading portion 30 in the printer 22. It is assumed that the recording media have been loaded in the recording medium loading portion 30 in a predetermined manner.

When the double-side synthetic mode is selected in the setting window described above, the computer 10 checks the form queue of the hard disk 23 of the controller 21 and displays in the “form list” in the form printing screen the filenames of the fixed image data stored in the form queue. The manner in which the fixed image data is stored in the form queue of the hard disk 23 of the controller 21 will be described later.

In the “form list”, the filename of the fixed image data to be actually printed on the recording media is selected out of a plurality of filenames of a plurality of pieces of fixed image data. The selection is carried out by reversing black and white of the filename in the form list of the setting screen with, for instance, a keyboard (not shown) of the computer 10 and the filename displayed in the reversed black and white is the selected filename. When the filename of the fixed image data is thus selected, the computer 10 reads out the image data having the selected filename from the hard disk 23 of the controller 21 and causes a fixed image to be displayed in the “form preview” in the setting screen on the basis of the fixed image data read out.

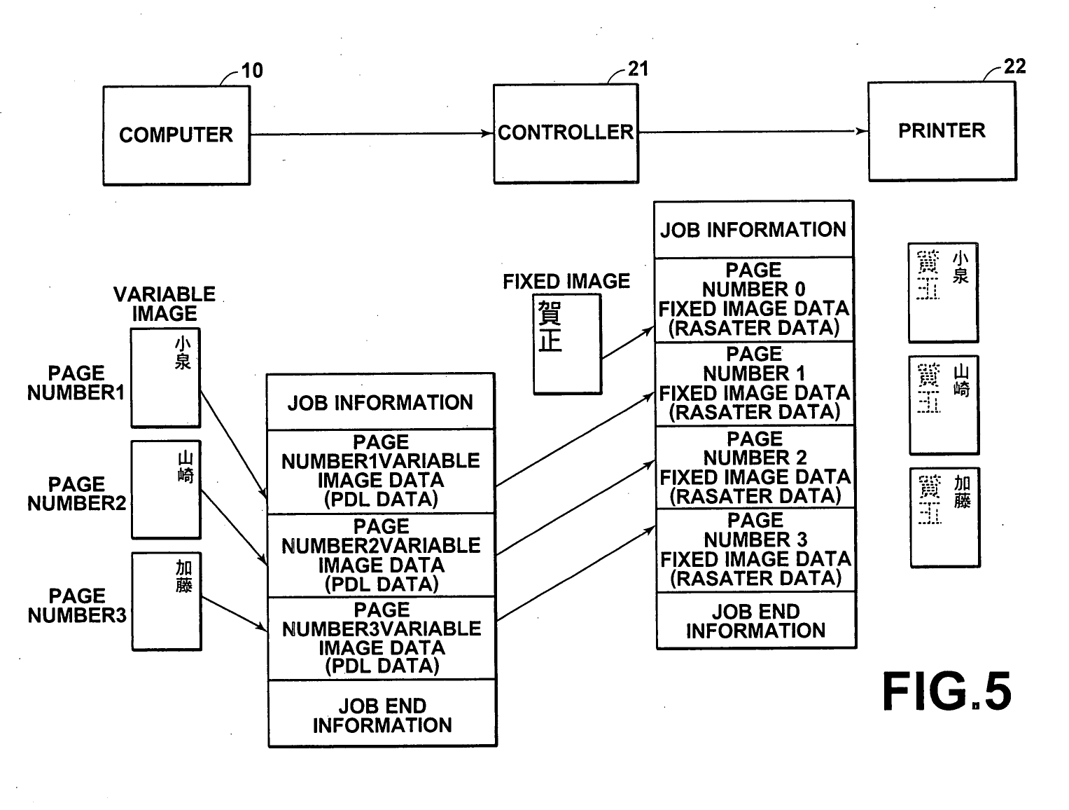

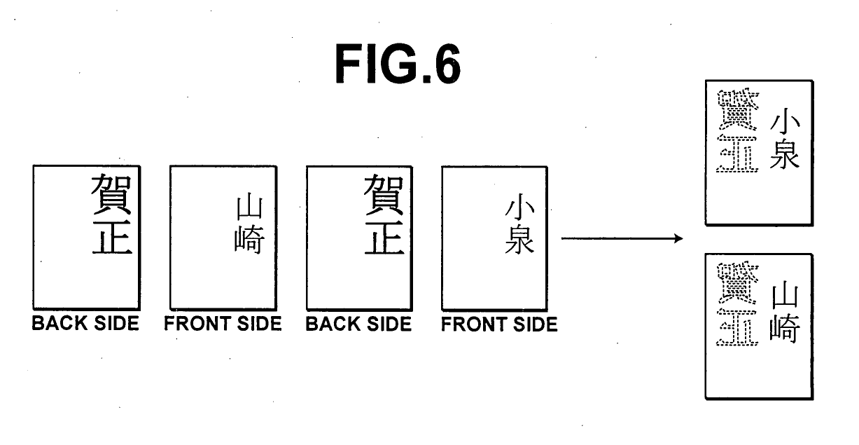

When an instruction to execute printing is made in the computer 10 after setting described above in the computer 10, variable image data transformed into the image data in the printer language (PDL data) is output to the controller 21 as shown in FIG. 5. As shown in FIG. 5, the layout, output destination, form printing pattern, form data printing side, filename of the fixed image data and the like selected in the setting window are added to the leading end of the variable image data as the job information while a job end information representing the end of the job is added to the trailing end of the variable image data, and the image data is output to the controller 21. In this particular embodiment, the case where the double-side printing is carried out on three (page number 1 to page number 3) recording media as shown in FIG. 5 will be described.

The controller 21 first recognizes the contents of the job information upon receipt of the variable image data and the like. When the double-side synthetic mode is instructed by the job information, the controller 21 reads out from the hard disk 23 the fixed image data having a filename designated in the job information and outputs the job information to the printer 22. Then the controller 21 carries out raster processing on the fixed image data read out from the hard disk 23 in the raster processing portion 24 and then outputs the raster processed fixed image data to the printer 22. At this time, the controller 21 attaches information representing the page number 0 to the raster processed fixed image data and outputs the raster processed fixed image data with the information to the printer 22.

The job information thus output from the controller 21 is input into the image formation control means 27 in the printer 22. The image formation control means 27 recognizes the input job information, and when the double-side synthetic mode is instructed by the job information, the image formation control means 27 receives fixed image data with information representing the page number 0 subsequently output from the controller 21 and causes the storage portion 25 to store the fixed image data with the information representing the page number 0 recognized. It has been set in advance that the image formation control means 27 stores the image data of the page number 0 in the storage portion 25. Though the image data of the page number 0 is stored in the storage portion 25 after the image data of the page number 0 is recognized to be a fixed image in this embodiment, for example, the image data received first after recognition of the job information may be recognized to be a fixed image and stored in the storage portion 25.

Then, next, in the controller 21, raster processing is carried out on the variable image data by the raster processing portion 24 and the raster processed variable image data is output to the printer 22 in sequence. When the variable image data of the page number 1 is input into the printer 22, the image formation control means 27 receives the variable image data of the page number 1 and temporarily stores it in the storage portion 25 and at the same time, reads out the fixed image data stored in the storage portion 25 and controls the print portion 26 to initiate printing of a fixed image. At this time, the fixed image is printed on the printing side (i.e. back side) designated in the form data set in the computer 10. Further, the image formation control means 27, upon end of printing of the fixed image by the print portion 26, controls the print portion 26 to print the variable image data temporarily stored in the storage portion 25. When the variable image of the page number 1 is ended, the image formation control means 27 receives the variable image data of the page number 2 and temporarily stores it in the storage portion 25 and at the same time, reads out the fixed image data stored in the storage portion 25 and controls the print portion 26 to initiate printing of a fixed image. When the variable image data of the page number 2 is to be stored, the variable image data of the page number has been cleared.

Further, the image formation control means 27, upon end of printing of the fixed image by the print portion 26, controls the print portion 26 to print the variable image on the basis of the variable image data of the page number 2 temporarily stored in the storage portion 25. The image formation control means 27 alternately repeats printing of the fixed image and printing of the variable image as described above to carry out the double-side printing on three recording media.

When printing of the variable image data of the page number 3 which is the last page number is ended, the job end information output from the controller 21 is input into the image formation control means 27 and the image formation control means 27 clears the fixed image data stored in the storage portion 25 in response to the job end information and turns into a waiting state until it receives another job information.

Though the variable image data is temporarily stored in the storage portion 25 and then a variable image is printed on the basis of the temporarily stored variable image data in this embodiment, it is not necessary to temporarily store the variable image data in the storage portion 25 but the variable image data may be directly input into the print portion 26 to provide for printing.

The fixed image and the variable image may be specifically printed on opposite sides of a recording medium in the following manner. First, a recording medium which has not been printed is taken out from the recording medium loading portion 30 shown in FIG. 2, and the recording medium is transferred by the transfer rollers 31 and the transfer passage 32 to the transfer belt 33. While the transfer belt 33 is fed in the direction of arrow A in FIG. 2, ink is injected from the ink jet head 34 according to the input fixed image data whereby print is made on the side set in the form setting screen, that is, in this embodiment, a fixed image is printed on the back side. The recording medium on one side of which the fixed image is thus printed is conveyed to the transfer rollers 35 and the transfer passage 36 by the transfer belt 33 and to the reverse transfer belt 37 by the transfer rollers 35 and the transfer passage 36. Then when conveyed to the reverse transfer passage 38 by the reverse transfer belt 37, the recording medium is reversed and transferred again to the transfer belt 33 by the reverse transfer passage 38 and the reverse transfer rollers 39. Then the recording medium is transferred to the inkjet head 34 in a reversed state by the transfer belt 33. While the recording medium is transferred by the transfer belt 33, ink is injected from the ink jet head 34 according to the variable image data whereby variable image is printed on the other side of the recording medium.

In accordance with the printer system described above, since the fixed image data output from the controller 21 is stored and held in the storage portion 25 in the printer 22, and the fixed image data stored in the storage portion 25 is read out and a fixed image is formed on one side of a plurality of recording media while a variable image data output from the controller 21 is received and variable image is formed on the other side of the recording media by the image formation control means 27, the number of times which the fixed image data is transferred from the controller 21 to the printer 22 can be reduced and the fixed image transfer time is shortened, whereby the printing efficiency can be improved.

In the printer system described above, the fixed image to be printed can be selected from a plurality of kinds of fixed images as described above. Procedure for storing in the controller 21 a plurality of pieces of fixed image data representing a plurality of fixed images will be described hereinbelow.

When the printing is instructed in, for instance, an application for editing in the computer 10, the main setting screen such as shown in FIG. 3 is displayed by the printer driver 11 of the computer 10. When the form queue is selected in the setting of “output destination” in the main setting screen and the printing is executed in this state, the fixed image data edited by the application of the computer 10 is output to the controller 21 after transformed to those in the printer language by the printer driver 11 and is stored in the form queue of the hard disk 23 of the controller 21. In the procedure described above, a plurality of kinds of fixed image data are stored in the form queue of the hard disk 23 of the controller 21. Then the filenames of a plurality of pieces of the fixed image data stored in the form queue of the hard disk 23 of the controller 21 are displayed in a list in the form printing screen of the computer 10 as shown in FIG. 4.

When the filenames of a plurality of pieces of the fixed image data stored in the form queue of the hard disk 23 of the controller 21 are displayed in a list, the filenames may be displayed at one time or may be displayed in sequence. Further, a plurality of pieces of fixed image data may be grouped and the group name may be displayed. Otherwise, by selecting a group name, the filename of the fixed image data in the group may be displayed.

When the hold queue is selected as the “output destination” in the main setting screen of the setting window shown in FIG. 3, the fixed image data output from the computer 10 is input into the controller 21 after transformed to those in the printer language by the printer driver 11 and is stored in the hold queue of the hard disk 23 of the controller 21. In this case, the fixed image in the printer language is only stored and the filenames of the fixed image are not displayed in a list unlike the case described above.

Further, though, in the printer system of the embodiment described above, a printer of an ink jet system is employed as the image forming apparatus, other image forming apparatuses e.g., a laser printer, may be employed.

Further, though, in the printer system of the embodiment described above, the fixed image data and the variable image data are output from the computer 10, they may be obtained by reading out with a scanner so that the double-side printing is carried out in the same manner as described above on the basis of the fixed image data and the variable image data output from the scanner.

Further, though, in the printer system of the embodiment described above, the computer 10 and the controller 21 form the printing information output unit as said in this invention and the printer 22 forms the image forming apparatus as said in this invention, the arrangement of the present invention need not be limited to such an arrangement. For example, the computer 10 may form the printing information output unit as said in this invention and the printer 22 and the controller 21 may form the image forming apparatus as said in this invention. In this case, for instance, the hard disk 23 of the controller 21 is regarded as the storage portion of the image forming apparatus as said in this invention without providing the storage portion 25 in the printer 22 and the fixed image data stored in the hard disk 23 is repeatedly used to carry out the double-side printing described above. When such an arrangement is employed, the traffic between the computer 10 and the controller 21 is not unnecessarily increased.

Further, by accommodating the controller 21 and the printer 22 in a casing which is essentially one and forming the controller 21 and the printer 22 integrally with each other, and by providing the printer 22 with the storage portion 25 as in the above embodiment, the double-side printing may be carried out in the same manner as described above.

1. An image forming system which is for forming a fixed image on one sides of a plurality of recording media and variable images different from each other on the other sides of the recording media and comprises a printing information output unit which outputs fixed image data representing the fixed image and a plurality of pieces of variable image data each representing a variable image, and an image forming apparatus which forms images on opposite sides of the recording media on the basis of the fixed image data and the variable image data output from the printing information output unit, wherein the improvement comprises
a storage portion which is provided in the image forming apparatus to store the fixed image data output from the printing information output unit,
a printing information output control means which causes the storage portion to store the fixed image data output from the printing information output unit and to hold the stored fixed image data until it is used for image formation of the fixed image on a plurality of recording media, and
an image formation control means which controls the image forming apparatus to read out the fixed image data held in the storage portion to form fixed images on one sides of a plurality of recording media and to receive a plurality of pieces of the variable image data output from the printing information output unit to form variable images on the other sides of a plurality of the recording media.

2. An image forming system as defined in claim 1 in which the printing information output unit displays in a list a plurality of pieces of information representing a plurality of pieces of fixed image data which are stored in advance, and at the same time, has a fixed image selecting means through which image data representing a fixed image to be formed on said one sides of the recording media can be selected out of the plurality of fixed image data.

3. An image forming apparatus which is for a image forming system defined in claim 1 and comprises
a storage portion which stores the fixed image data output from the printing information output unit, and
an image formation control means which controls the image forming apparatus to read out the fixed image data held in the storage portion to form fixed images on one sides of a plurality of recording media and to receive a plurality of pieces of the variable image data output from the printing information output unit to form variable images on the other sides of a plurality of the recording media.

4. An image forming system which is for forming a fixed image on one sides of a plurality of recording media and variable images different from each other on the other sides of the recording media and comprises a computer which outputs variable image data representing the variable image of a plurality of pages, a controller which is provided with a variable image data receipt portion which receives the variable image data output from the computer and an image storage portion which stores a plurality of pieces of fixed image data each representing a fixed image, and outputs the variable image data received by the variable image data receipt portion and a fixed image data stored in the image storage portion and a printer which forms images on opposite sides of the recording media on the basis of the fixed image data and the variable image data output from the controller, wherein the improvement comprises that
the computer outputs to the controller fixed image designation information for designating one of the plurality of pieces of fixed image data,
the controller selects one of the plurality of pieces of fixed image data from the image storage portion on the basis of the fixed image designation information output from the computer and outputs the selected fixed image data to the printer and thereafter outputs the variable image data of the plurality of pages to the printer, and
the printer is provided with a storage portion which stores the fixed image data output from the controller, a printing information output control means which causes the storage portion to store the fixed image data and to hold the stored fixed image data until it is used for image formation of the fixed image on a plurality of recording media, and an image formation control means which controls the image forming apparatus to read out the fixed image data held in the storage portion to form fixed images on one sides of a plurality of recording media and to receive a plurality of pieces of the variable image data output from the controller to form variable images on the other sides of a plurality of the recording media.

5. An image forming system as defined in claim 4 in which the controller and the printer is formed integrally with each other.
